(19) United States
(12) Patent Application Publication
(10) Pub. No.: US 2016/0329029 A1
(43) Pub. Date: Nov. 10, 2016

(54) APPARATUS AND METHOD FOR INTEGRATING A SMART MOBILE DEVICE AND A TOUCH DEVICE

(71) Applicant: Twinwill Optronics Inc., Taipei (TW)

(72) Inventor: TZAN-WEI LIU, New Taipei (TW)

(21) Appl. No.: 14/969,681

(22) Filed: Dec. 15, 2015

Related U.S. Application Data
(60) Provisional application No. 62/159,345, filed on May 10, 2015.

(51) Int. Cl. G09G 5/12; G09G 5/08; G06F 3/14; G06F 3/0488; G09G 5/00

(52) U.S. Cl. CPC G09G 5/12; G06F 3/04883; G09G 5/005; G06F 3/1454; G09G 5/08; G09G 2370/16

(57) ABSTRACT

An electronic device duplicating information displayed by another electronic device and further able to control the another electronic device includes a communication unit, a display unit, a sensor, and a processor. The communication unit identifies and establishes connectivity with another electronic device. The display unit displays information synchronously with the another electronic device. The sensor detects a touch event on the display unit. The processor controls the another electronic device to perform corresponding action or event as well in the electronic device based on the touch event on the display unit.

### CROSS-REFERENCE TO RELATED APPLICATIONS

This application claims priority to and the benefit of U.S. Provisional Application No. 62/159,345, filed on May 10, 2015, entitled, “APPARATUS AND METHOD FOR INTEGRATING SMART MOBILE DEVICE AND TOUCH DEVICE”, the disclosure of which is incorporated by reference herein in its entirety.

### FIELD

The subject matter herein generally relates to a system and method for an electronic device controlling other electronic device, and, in particular embodiments, to a system and method for configuring two electronic devices with each other to enable enhanced functionalities through their combination.

### BACKGROUND

The information exchanged between electronic devices through a network, or other media is governed by rules and conventions that can be set out in technical specifications. In digital computing systems, the rules can be expressed by algorithms and data structures. Expressing the algorithms in a portable programming language makes the protocol software independent of the operating system.

Protocols, which can be embedded in the process code itself, enable operating systems to intercommunicate. In contrast, because there is no common memory, communicating systems have to communicate with each other using a shared transmission medium. Transmission is not necessarily reliable, and individual systems may use different hardware and/or operating systems.

To implement a networking protocol, the protocol software modules are interfaced within a framework implemented on the machine's operating system. This framework implements the networking functionality of the operating system. The best known frameworks are the TCP/IP model and the OSI model. Layering provides a successful design approach for both compiler and operating system designer and, given the similarities between programming languages and communication protocols, layering can be applied to the protocols as well. This gives rise to the concept of layered protocols which can forms the basis of protocol design.

Mobile phone devices and computers can be shipped with data cable such as universal serial bus (USB) cable to allow them to be interconnected, allowing for synchronization of email for example between the two devices. In the beginning, the mobile phone with an integration capability was primarily used to check emails received while users were away from their desks.

A mobile phone can also act as a modem. That is, a computer can be tethered to a mobile phone in order to provide internet connectivity to the computer.

Modern mobile devices are sufficiently powerful to serve as full functional computing devices, one mobile device with great mobility may run into incontinences such as limited screen size and another mobile device may be lack of sufficient computing capability but with larger screen size. The integration of two electronic devices can enable expanded features such as extendable/extra display and extra input/control over another electronic device. An extended/extra display can be realized by wiring a first device such as cell phone to a second device such as touch display through USB or High-Definition Multimedia Interface (HDMI®) cable connection. Such connection can also be done wirelessly through Wi-Fi. Extra input/control device may include keyboard, mouse, etc. connected with wire or wirelessly. For connecting electronic devices to allow both extra display and control ability, a pairing with additional dongle is essential.

A second device that can display the first device's content, such as on an extra display monitor for example, may not have the capability to control the first device; a second device that only controls the first device, such as a mouse or other input device for example, is not able to duplicate information displayed by the first device.

Designs that can enable bi-directional display or control mostly require both first device and second device to be within a single computing system, with a complete operating system (OS). If the second device does not contain a complete OS, the software or driver that handles the display and control needs to obtain administrative authority from the first device and may put the security of the first device at risk. In these circumstances, the second device may only obtain limited control of the first device.

A Human Interface Device (HID) is a type of protocol for computer device that interacts directly with, and takes most input from, humans, and may deliver output to humans supported by bi-directional communication. In the HID protocol, there are two entities, the “host device” and the “slave device”. The slave device is the entity that directly interacts with a human, such as a keyboard, mouse, or display. The host device communicates with the slave device and receives input data from the slave device on actions performed by a human.

A solution to the convergence problem may be a second device with a capability of camouflaging controls from itself to controls authorized by the HID control unit of the first device.

### BRIEF DESCRIPTION OF THE DRAWINGS

Implementations of the present technology will now be described, by way of example only, with reference to the attached figures.

FIG. 1 is a block diagram of an embodiment of a conjunction of a computing device and an electronic device.

FIGS. 2-3 show a flow chart of simulating a tap motion on the electronic device into a click motion on the computing device of the embodiment of FIG. 1.

FIGS. 4-5 show a flow chart of simulating a zoom in/zoom out motion on the electronic device into a zoom in/zoom out motion on the computing device of the embodiment of FIG. 1.

FIG. 6 is a diagrammatic view of one embodiment of a conjunction of a smart phone and a large display monitor with integrated touch module.

FIG. 7 is a diagrammatic view of another embodiment of a conjunction of a smart phone and a touch panel used for a conference.

FIG. 8 is a diagrammatic view of another embodiment of a conjunction of a smart phone and an infotainment system.

### DETAILED DESCRIPTION

This disclosure applies to a computing device operable to work in conjunction with an electronic device, in which the computing device and the electronic device each can have their own electronic components and/or own OS and each is able to construct a partial or complete user environment. The computing device can include a processor, a complete operating system (OS), and a communication unit. The electronic device may be a device combining touch sensibility and large display that includes a processor, a memory, a touch HID control board, and a communication unit. The processor of the computing device and the processor of the electronic device may include display functions such as Miracast, MirrorLink, Mobile High-Definition Link (MHL), Digital Living Network Alliance (DLNA), Wireless Display (WiDi), Wireless Gigabit Alliance (WIGig), and AirPlay®. The communication unit of the computing device and the communication unit of the electronic device can include wired and wireless transmitting capabilities such as Wi-Fi, Bluetooth®, USB, HDMI®, and Near Field Communication (NFC), and Ethernet.

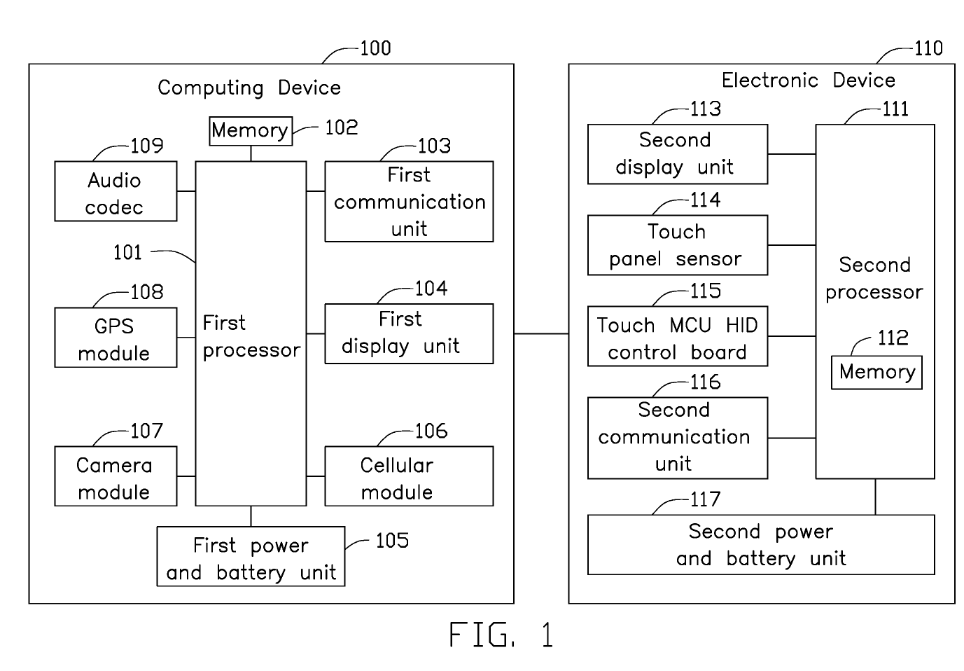

Embodiments are described with reference to FIGS. 1-8. However, those skilled in the art will readily appreciate that the detailed descriptions given herein with respect to these figures is for explanatory purposes as the applications extend beyond these embodiments.

FIG. 1 illustrates an embodiment of a conjunction of a computing device 100 and an electronic device 110. One of the embodiments can include a conjunction between the computing device 100 and the electronic device 110. The computing device 100 can comprise a first processor 101, a memory 102, a first communication unit 103, a first display unit 104, and a first power and battery unit 105. The first processor 101 can be a central processing unit, a digital processor, or a single chip, for example. The first processor 101 can be coupled to the memory 102, the first communication unit 103, the first display unit 104, and the first power and battery unit 105. The memory 102 can include, but is not limited to, RAM, ROM, EPROM, EEPROM, flash memory, or other solid state memory technology. The memory 102 can store information of the computing device 100 and store a computer program which can be executed by the first processor 101. The first communication unit 103 can be configured to enable a communication between the computing device 100 and the electronic device 110. The first display unit 104 can be a liquid crystal display, an organic light-emitting diode, or the like. The first power and battery unit 105 can be configured to provide power for the computing device 100. The computing device 100 may be a smart phone which further comprises a cellular module 106, a camera module 107, a GPS module 108, and an audio codec 109 to obtain telecommunication capability.

The electronic device 110, on the other hand, can comprise a second processor 111 with a memory 112, a second display unit 113, a touch panel sensor 114, a Touch MCU HID control board 115, a second communication unit 116, and a second power and battery unit 117. The second processor 111 can be a central processing unit, a digital processor, or a single chip, for example. The second processor 111 can be coupled to the memory 112, the second display unit 113, the touch panel sensor 114, the Touch MCU HID control board 115, the second communication unit 116, and the second power and battery unit 117. The memory 112 can include, but is not limited to, RAM, ROM, EPROM, EEPROM, flash memory, or other solid state memory technology. The memory 112 can store a computer program which can be executed by the second processor 111. The second display unit 113 can be a liquid crystal display, an organic light-emitting diode, or the like. The second display unit 113 can be configured to display information. The touch panel sensor 114 can be configured to detect touch events on the second display unit 113. The touch events can be triggered by finger(s), stylus, pointer, mouse, keyboard, or any type of device that could send the point of touch on the second display unit 113 to the touch panel sensor 114. The Touch HID control board 115 can be a circuit fixed in the electronic device 110. The Touch HID control board 115 can be configured to process any sensed touch event. The second power and battery unit 117 can be configured to provide power for the electronic device 110.

The computing device 100 can detect a signal transmitted from the electronic device 110 when the electronic device 110 is within the range of detection of the computing device 100, or directly connected to the computing device 100. After certification procedures to complete the synchronization of image and touch/control signal, a display parameter (LCD resolution, for example) can be sent from the first communication unit 103 of the computing device 100 to the second communication unit 116 of the electronic device 110. The electronic device 110 can then adjust its resolution accordingly and display the information synchronously with the first display unit 104 on the second display unit 113 transmitted through a first transmitting route, such as USB or Wi-Fi, from the computing device 100. The second display unit 113 of the electronic device 110 may duplicate information displayed by the first display unit 104. The computing device 100, on the other hand, can connect the Touch MCU HID control board 115 or the second processor 111 in the electronic device 110 through a second transmitting route such as Bluetooth® and enable the electronic device 110 to control the computing device 100. In the embodiment, the second transmitting route can be same as or different from the first transmitting route.

The process of the conjunction of the computing device 100 and the electronic device 110 may differ in signal routing. If the electronic device 110 is to display the information from the computing device 100 transmitted through Wi-Fi, the computing device 100 may target the electronic device 110 as a Miracast device using Wi-Fi Direct. The Wi-Fi Direct is a Wi-Fi standard enabling devices to easily connect with each other without requiring a wireless access point. Once the electronic device 110 is targeted, it will transmit the needed Wi-Fi parameter through Dynamic Host Configuration Protocol (DHCP) to the computing device 100. By the time the computer device 100 and the electronic device 110 are wirelessly connected through Wi-Fi, the computing device 100 can transmit the information through the described route to the electronic device 110.

The computing device 100 and the electronic device 110 may also be integrated with wire. For example, the computing device 100 can be a smart phone supporting MHL or MirrorLink® and connect with the electronic device 110 through USB. To realize such connection, the electronic device 110 can be equipped with wired communication unit such as HDMI® and USB connectors. The information from the computing device 100 can then be transmitted to the electronic device 110 via micro-USB to HDMI® cable. If the wired communication unit on the electronic device 110 is integrated with USB-to-HDMI® data conversion, the conjunction can be achieved with micro-USB to USB cable.

When a touch HID control signal is transmitted from the electronic device 110 to the computing device 100 via Bluetooth®, the capability can be restricted by the need for administrative authority in the computing device 100. One way to avoid this restriction is to camouflage the touch HID control signal from the electronic device 110 into an HID control signal that is authorized by the computing device 100. For example, if the computing device 100 accepts an HID control signal from an external mouse, the Touch MCU HID control board 115 or the second processor 111 on the electronic device 110 will then transform the touch HID control signal into a signal that the computing device 100 recognizes as an external mouse HID control signal.

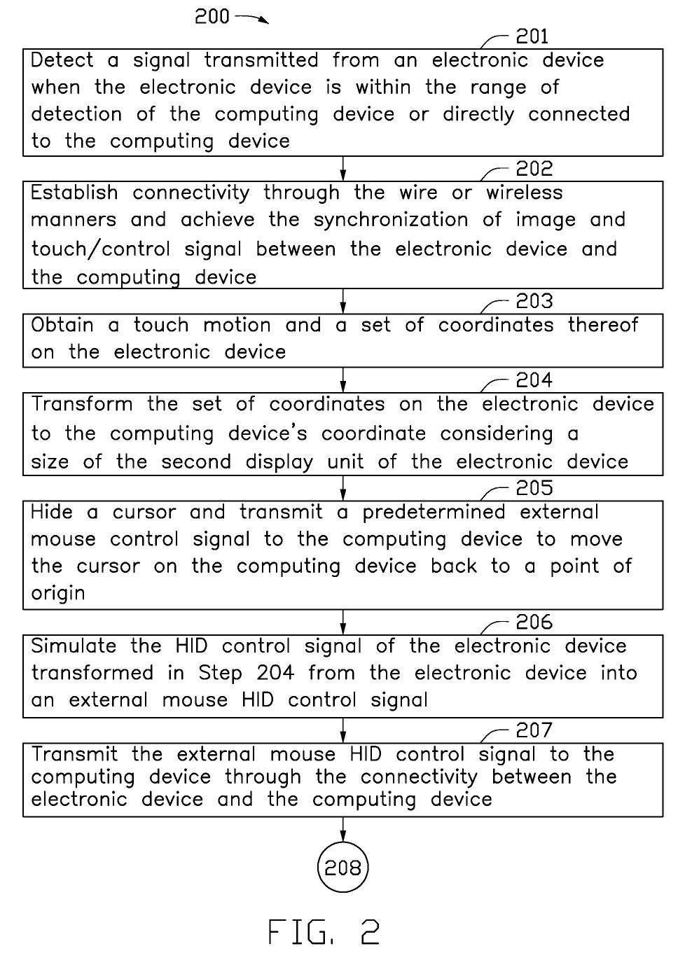

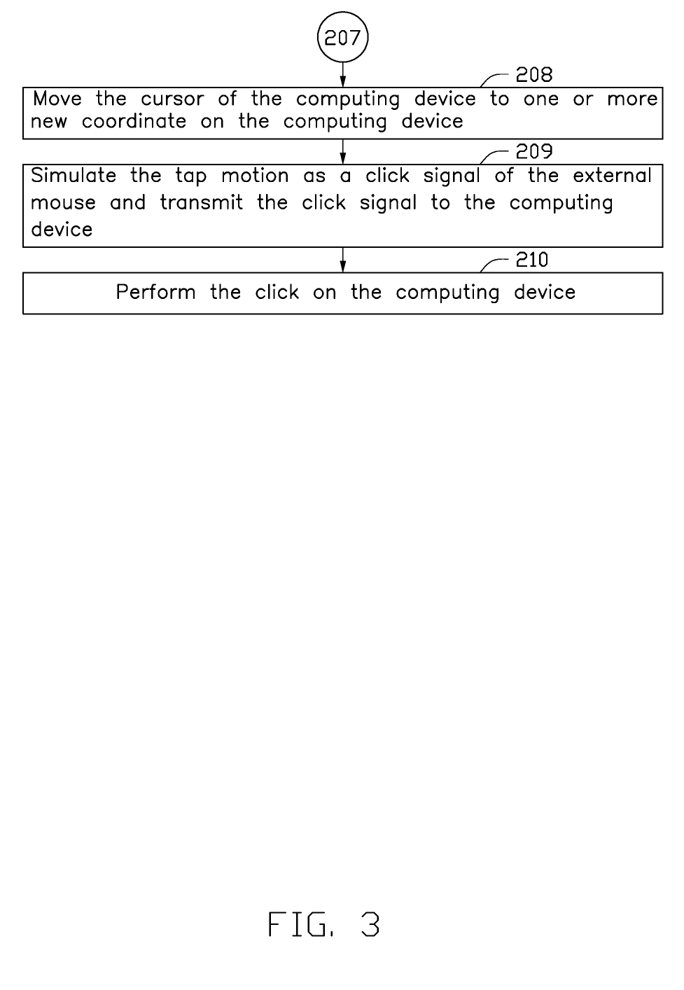

FIGS. 2-3 illustrate a flow chart of a tap motion simulating method 200 for simulating a tap motion on the electronic device into a click motion on the computing device of the embodiment of FIG. 1. The tap motion on the electronic device can be one or more locations touched by finger or other tool on the electronic device. Since the set of coordinates of a touch event that the second processor 111 returns are absolute coordinates, whereas an external mouse will map the absolute coordinates of the touch event to relative coordinates. The tap motion simulating method 200 simulates a tap motion on the electronic device into a click motion on the computing device.

The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIGS. 2-3 represents one or more processes, methods, or subroutines carried out in the exemplary method 200. Furthermore, the illustrated order of blocks is by example only and the order of the blocks can change according to the present disclosure. Additional blocks may be added or fewer blocks may be utilized, without departing from this disclosure. The tap motion simulating method 200 can begin at block 201.

At block 201, a computing device detects a signal transmitted from an electronic device when the electronic device is within the range of detection of the computing device, or directly connected to the computing device.

At block 202, after certification procedures to establish connectivity, through the wire or wirelessly manners, and the synchronization of image and touch/control signal between the electronic device and the computing device is achieved.

At block 203, a touch event, such as a tap motion, for example, and a set of coordinates thereof on the electronic device are obtained.

At block 204, the set of coordinates of the touch event on the electronic device are transformed to the computing device's coordinate considering a size of the second display unit of the electronic device.

At block 205, a cursor is hidden and a predetermined external mouse control signal, such as an HID control signal of the electronic device, is transmitted to the computing device to moves the cursor on the computing device back to a point of origin.

At block 206, an HID control signal of the electronic device transformed by the process of block 204 from the electronic device is simulated into an external mouse HID control signal.

At block 207, the external mouse HID control signal is transmitted to the computing device through the connectivity between the electronic device and the computing device.

At block 208, the cursor of the computing device is moved to one or more new sets of coordinates on the computing device according to the external mouse HID control signal, where the cursor of the computing device can be moved to one or more new sets of coordinates on the computing device in sequence.

At block 209, the tap motion described in block 203 is simulated as a click signal of the external mouse and the click signal is transmitted to the computing device.

At block 210, the click motion is performed on the computing device.

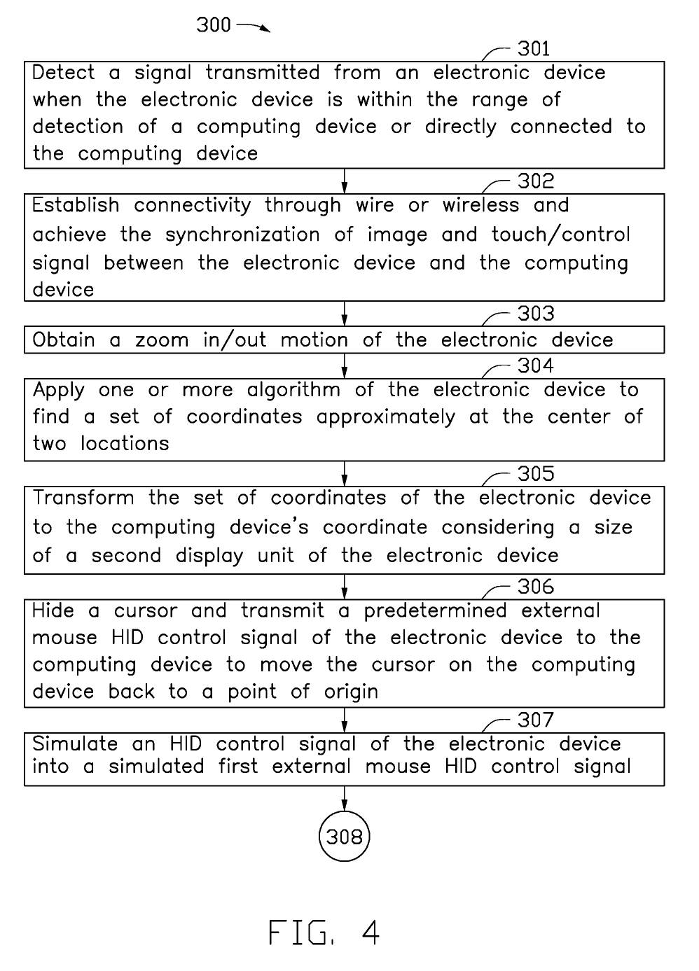

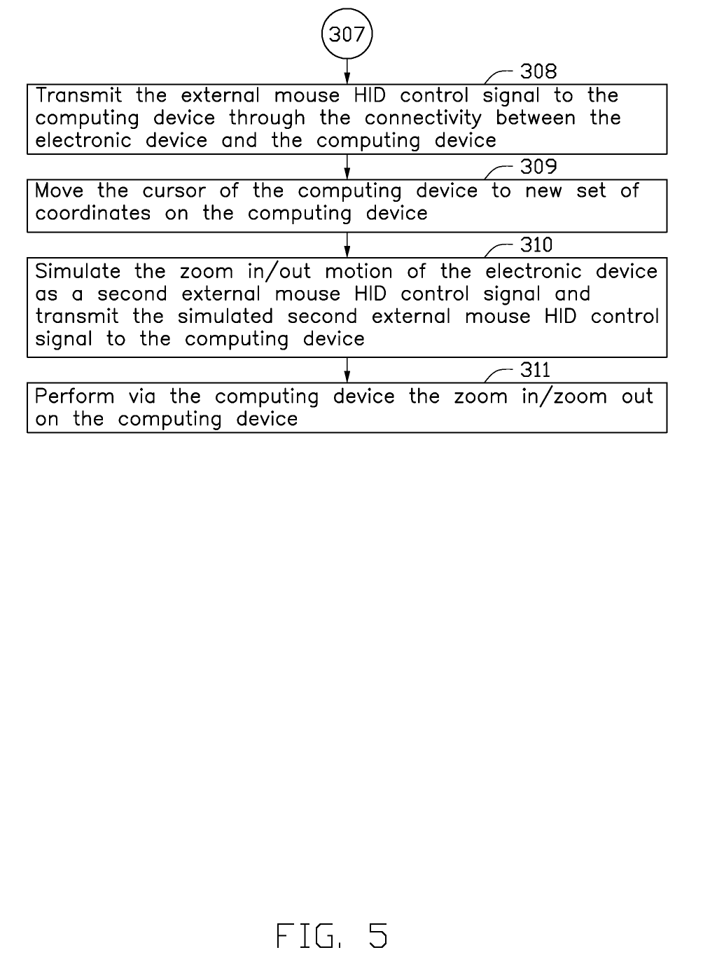

FIGS. 4-5 illustrates a flow chart of a zoom in/zoom out motion simulating method 300 for simulating a zoom in/zoom out motion on the electronic device into a zoom in/zoom out motion on the computing device of the embodiment of FIG. 1. In another embodiment, the zoom in/zoom out motion simulating method 300 for manipulating a computing device by simulating a touch HID control signal as an external mouse HID control signal.

The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIGS. 4-5 represents one or more processes, methods, or subroutines carried out in the exemplary method 300. Furthermore, the illustrated order of blocks is by example only and the order of the blocks can change according to the present disclosure. Additional blocks may be added or fewer blocks may be utilized, without departing from this disclosure. The zoom in/zoom out motion simulating method 300 can begin at block 301.

At block 301, the computing device detects a signal transmitted from the electronic device when the electronic device is within the range of detection of the computing device, or directly connected to the computing device.

At block 302, after certification procedures to establish, connectivity through wire or wirelessly manners, and the synchronization of image and touch/control signal between the electronic device and the computing device is achieved.

At block 303, a zoom in/zoom out motion of the electronic device, comprising information as to a gesture simultaneously at or on the second display unit of the electronic device, is obtained.

At block 304, one or more algorithms of the electronic device are applied to find a set of coordinate approximate at the center of two relevant locations.

At block 305, the approximate set of coordinates of the electronic device is transformed to the computing device's coordinate considering a size of the second display unit of the electronic device.

At block 306, a cursor is hidden and a predetermined external mouse HID control signal of the electronic device is transmitted to the computing device to move the cursor on the computing device back to a point of origin.

At block 307, an HID control signal of the electronic device, transformed by the process of block 305, is simulated into a first external mouse HID control signal.

At block 308, the first external mouse HID control signal is transmitted to the computing device through the connectivity between the electronic device and the computing device.

At block 309, the cursor of the computing device is moved to new set of coordinates on the computing device according to the first external mouse HID control signal.

At block 310, the zoom in/zoom out motion of the electronic device recorded in block 303 is simulated as a second external mouse HID control signal and the simulated second external mouse HID control signal is transmitted to the computing device.

At block 311, the computing device performs the zoom in/zoom out motion on the computing device.

The second external mouse HID signal can be a zoom in/zoom out signal via a scroll wheel on the external mouse. If the zoom in/zoom out motion via scroll wheel is not supported, the computing device can apply a preinstalled mobile application to transform the second external mouse HID signal into a zoom in/zoom out motion carried out by two fingers simultaneously at the second display unit of the electronic device, and the computing device performs the zoom in/zoom out motion accordingly.

Although a specific process of the first processor and a specific process of the second processor is shown and described with reference to FIG. 1, for purposes of illustration only, any suitable change of the process of the first processor and the process of the second processor can be provided. For example, the second processor can transform the touch event into a control signal and transmit the control signal to the first processor through the second transmitting route, the first processor can accordingly transform the control signal into an external mouse control signal which is acceptable to control the computing device, thereby controlling the computing device to perform the corresponding action of the external mouse control signal as well in the electronic device.

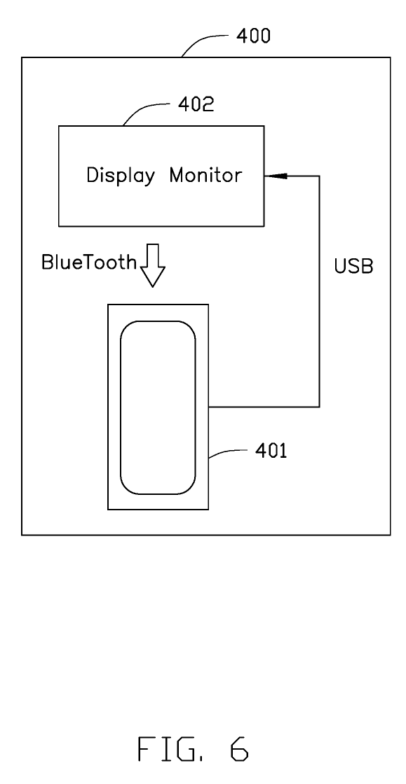

FIG. 6 illustrates one embodiment of a conjunction 400 of a smart phone 401 and a large display monitor 402 with integrated touch module. In at least one embodiment, the simulation of an HID control signal realizes an integration of a smart phone 401 with a large display monitor 402 with integrated touch module. The large display monitor 402 displays content displayed by the smart phone 401 and controls the smart phone 401 through the integrated touch module. Information from the smart phone 401 is transmitted to the large display monitor 402 via a wired connection such as USB while the control signal is transmitted from the large display monitor 402 to the smart phone 401 via Bluetooth®.

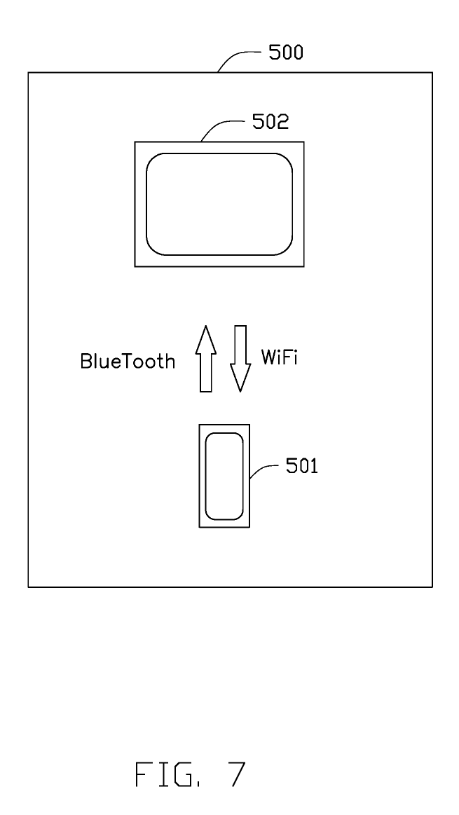

FIG. 7 illustrates another embodiment of a conjunction 500 of a smart phone 501 and a sized touch panel 502 used for conference. Another embodiment adapting the simulation of an HID control signal comprises a sized touch panel 502 used for conference and a smart phone 501. The sized touch panel 502 displays content of the smart phone 501 and controls with touch or pointer function on the sized touch panel 502.

The information from the smart phone 501 is transmitted to the sized touch panel 502 via wireless connection such as Wi-Fi while the control signal is transmitted from the sized touch panel 502 to the smart phone 501 via Bluetooth®.

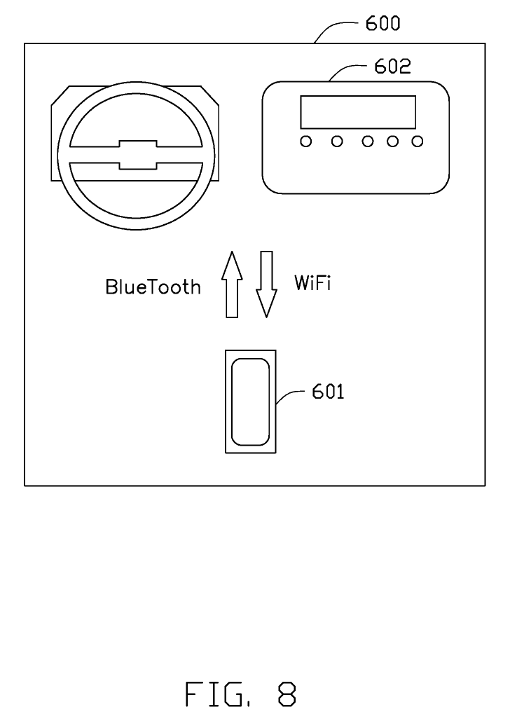

FIG. 8 illustrates another embodiment of a conjunction 600 of a smart phone 601 and an infotainment system 602. In another embodiment, the simulation of touch

HID control signal realizes an integration of smart phone 601 with the infotainment system 602 on automobile. After certification procedures to complete the synchronization of image signal, a display parameter (LCD resolution, for example) can be sent from the smart phone's communication unit to the communication of the infotainment system 602 on automobile. In order for the infotainment system 602 to obtain access to the smart phone 601, the touch HID control signal transmitted from the infotainment system 602 can first be simulated as an HID control signal that is authorized by the smart phone 601 via Bluetooth®. Once the connection between the smart phone 601 and the infotainment system 602 is complete, a user may then pick up a phone call, or use the GPS navigation application, through the touch panel of the infotainment system 602.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A system comprising:
a first electronic device comprising:
a first display unit;
a first communication unit; and
a first processor coupled to the first display unit and the first communication unit; and
a second electronic device comprising:
a second communication unit configured to identify and establish connectivity with the first communication unit;
a second display unit configured to display information synchronously with the first display unit, thereby enabling the second display unit to duplicate information displayed by the first display unit;
a sensor configured to detect a touch event on the second display unit; and
a second processor coupled to the second communication unit, the second display unit, and the sensor, the second processor being configured to control the first processor to perform corresponding action as well in the second electronic device based on the touch event on the second display unit.

2. The system of claim 1, wherein the first communication unit and the second communication unit form a first transmitting route, the synchronous information is provided from the first electronic device to the second electronic device through the first transmitting route.

3. The system of claim 2, wherein the first communication unit and the second communication unit form a second transmitting route, the second electronic device controls the first electronic device through the second transmitting route.

4. The system of claim 3, wherein the first transmitting route and the second transmitting route are different.

5. The system of claim 3, wherein the second processor is further configured to:
transform the touch event on the second display unit into a control signal;
simulate the control signal into an external mouse control signal which is acceptable to control the first electronic device; and
transmit the external mouse control signal to the first electronic device through the second transmitting route, thereby the first electronic device performs the corresponding action of the external mouse control signal as well in the second electronic device.

6. The system of claim 3, wherein:
the second processor is further configured to transform the touch event into a control signal and transmit the control signal to the first electronic device through the second transmitting route;
the first processor is further configured to transform the control signal into an external mouse control signal which is acceptable to control the first electronic device, thereby the first electronic device performs the corresponding action of the external mouse control signal as well in the second electronic device.

7. The system of claim 1, wherein the control signal is a human interface device control signal for controlling the first electronic device to perform the corresponding action as well in the second electronic device.

8. The system of claim 1, wherein the connectivity between the first electronic device and the second electronic device is established through a wire connection.

9. The system of claim 1, wherein the connectivity between the first electronic device and the second electronic device is established through a wireless connection.

10. The system of claim 1, wherein the second processor is further configured to:
obtain one or more sets of coordinates of the second electronic device;
transform the one or more sets of coordinates of the second electronic device to the first electronic device's coordinate considering a size of the second display unit of the second electronic device;
hide the cursor and transmit a predetermined external mouse control signal to the first electronic device that moves the cursor on the first electronic device back to a point of origin;
simulate the transformed control signal of the second electronic device from the second electronic device into an external mouse control signal;
transmit the simulated external mouse control signal to the first electronic device through the connectivity between the second electronic device and the first electronic device; and
move a cursor of the first electronic device to one or more new sets of coordinates on the first electronic device according to the external mouse control signal.

11. The system of claim 10, wherein the touch event is made of one or more locations touched on the second electronic device.

12. The system of claim 11, wherein the one or more sets of coordinates of the second electronic device obtained by a corresponding second processor are the sets of coordinates of the one or more locations touched on the second electronic device.

13. The system of claim 10, wherein the touch event is made of gesture information simultaneously at the second display unit.

14. The system of claim 13, wherein the one or more sets of coordinates of the second electronic device obtained by a corresponding second processor are the set of coordinates approximately at the center of the two locations of the gesture information found via applying one or more algorithm of the second electronic device.

15. A method for pairing a first electronic device and a second electronic device, the method comprising:
identifying an authorized relationship between the first electronic device and the second electronic device;
establishing a connectivity between the first electronic device and the second electronic device;
enabling the display information synchronous between the first electronic device and the second electronic device, thereby the second electronic device duplicating information displayed by the first electronic device;
detecting one or more touch events of the second electronic device; and
controlling the first electronic device to perform corresponding action as well in the second electronic device based on the one or more touch events on the second electronic device.

16. The method of claim 15, wherein the first electronic device and the second electronic device form a first transmitting route, the synchronous information is provided from the first electronic device to the second electronic device through the first transmitting route.

17. The method of claim 16, wherein the first electronic device and the second electronic device further form a second transmitting route, the second electronic device control the first electronic device through the second transmitting route.

18. The method of claim 17, wherein the first transmitting route and the second transmitting route are different.

19. The method of claim 17, wherein the method further comprises:
transforming the one or more touch events on the second electronic device into one or more control signals;
simulating the one or more control signals into one or more external mouse control signals which are acceptable to control the first electronic device; and
transmitting the one or more external mouse control signals to the first electronic device through the second transmitting route, thereby the first electronic device performs the corresponding action of the one or more external mouse control signals as well in the second electronic device.

20. The method of claim 17, wherein the method further comprises:
transforming the one or more touch events on the second electronic device into one or more control signals;
transmitting the transformed one or more control signals to the first electronic device through the second transmitting route; and
simulating the one or more control signals into one or more external mouse control signals which are acceptable to control the first electronic device, thereby the first electronic device performs the corresponding action of the one or more external mouse control signals as well in the second electronic device.

21. The method of claim 15, wherein the connectivity between the first electronic device and the second electronic device is established through a wire connection.

22. The method of claim 15, wherein the connectivity between the first electronic device and the second electronic device is established through a wireless connection.

23. The method of claim 15, wherein the method further comprises:
obtaining one or more sets of coordinates of the second electronic device;
transforming the one or more sets of coordinates of the one second electronic device to the first electronic device's coordinate considering a size of a display unit of the second electronic device;
hiding the cursor and transmitting a predetermined external mouse control signal to the first electronic device that moves the cursor on the first electronic device back to a point of origin;
simulating the transformed control signal of the second electronic device from the second electronic device into an external mouse control signal;
transmitting the simulated external mouse control signal to the first electronic device through the connectivity between the second electronic device and the first electronic device; and
moving a cursor of the first electronic device to the one or more new sets of coordinates on the first electronic device.

24. The method of claim 23, wherein the touch event is made of one or more locations touched on the second electronic device.

25. The method of claim 23, wherein the touch event is made of gesture information simultaneously at the second electronic device.

26. An electronic device, comprising:
a communication unit configured to identify and establish connectivity with another electronic device;
a display unit configured to display information synchronously with the another electronic device, thereby enabling the display unit to duplicate information displayed by the another electronic device;
a sensor configured to detect a touch event on the display unit; and
a processor coupled to the communication unit, the display unit, and the sensor, the processor being configured to control the another electronic device to perform corresponding action as well in the electronic device based on the touch event on the display unit.

27. The electronic device of claim 26, wherein the communication unit and the another electronic device form a first transmitting route, the synchronous information is provided from the another electronic device to the electronic device through the first transmitting route.

28. The electronic device of claim 27, wherein the communication unit and the another electronic device form a second transmitting route, the electronic device controls the another electronic device through the second transmitting route.

29. The electronic device of claim 28, wherein the first transmitting route and the second transmitting route are different.

30. The electronic device of claim 28, wherein the processor is further configured to:
transform the touch event on the display unit into a control signal;
simulate the control signal into an external mouse control signal which is acceptable to control the another electronic device; and
transmit the external mouse control signal to the another electronic device through the second transmitting route, thereby the another electronic device performs the corresponding action of the external mouse control signal as well in the electronic device.

31. The electronic device of claim 26, wherein the control signal is a human interface device control signal for controlling another electronic device to perform the corresponding action as well in the electronic device.

32. The electronic device of claim 26, wherein the connectivity between another electronic device and the electronic device is established through a wire connection.

33. The electronic device of claim 26, wherein the connectivity between another electronic device and the electronic device is established through a wireless connection.

34. The electronic device of claim 26, wherein the processor is further configured to:
obtain one or more sets of coordinates of the electronic device;
transform the one or more sets of coordinates of the electronic device to the another electronic device's coordinate considering a size of the display unit of the electronic device;
hide the cursor and transmit a predetermined external mouse control signal to the another electronic device that moves the cursor on the another electronic device back to a point of origin;
simulate the transformed control signal of the electronic device from the electronic device into an external mouse control signal;
transmit the simulated external mouse control signal to the another electronic device through the connectivity between the electronic device and the another electronic device; and
move a cursor of the another electronic device to the one or more new sets of coordinates on the another electronic device.

35. The electronic device of claim 34, wherein the touch event is made of one or more locations touched on the display unit.

36. The electronic device of claim 34, wherein the touch event is made of gesture information simultaneously at the display unit.

37. A method comprising:
identifying an authorized relationship of an electronic device to another electronic device;
establishing a connectivity of the electronic device to the another electronic device;
enabling the display information synchronous between the another electronic device and the electronic device, thereby duplicating information displayed by the another electronic device;
detecting a touch event of the electronic device; and
controlling the another electronic device to perform corresponding action as well in the electronic device based on the touch event on the electronic device.

38. The method of claim 37, wherein the connectivity between the another electronic device and the electronic device is established through a wire connection.

39. The method of claim 37, wherein the connectivity between the another electronic device and the electronic device is established through a wireless connection.

40. The method of claim 37, wherein the electronic device and the another electronic device form a first transmitting route, the synchronous information is provided from the another electronic device to the electronic device through the first transmitting route.

41. The method of claim 37, wherein the electronic device and the another electronic device further form a second transmitting route, the electronic device controls the another electronic device through the second transmitting route.

42. The method of claim 41, wherein the method further comprises:
transforming the touch event on the electronic device into a control signal;
simulating the control signal into an external mouse control signal which is acceptable to control the another electronic device; and
transmitting the external mouse control signal to the another electronic device through the second transmitting route, thereby the another electronic device perform the corresponding action of the external mouse control signal as well in the electronic device.
